(19) United States
(12) Patent Application Publication
(10) Pub. No.: US 2017/0217716 A1
(43) Pub. Date: Aug. 3, 2017

(54) HOSE MANUFACTURING MACHINE

(71) Applicant: Caterpillar Inc., Peoria, IL (US)

(72) Inventors: James J. Billimack, Metamora, IL (US); Amy C. Chastain, Edwards, IL (US); Alan T. Avery, West Plains, MO (US); David P. Wade, West Plains, MO (US)

(73) Assignee: Caterpillar Inc., Peoria, IL (US)

(21) Appl. No.: 15/489,880

(22) Filed: Apr. 18, 2017

(51) Int. Cl. B65H 59/04; F16L 11/10

(52) U.S. Cl. CPC B65H 59/04; F16L 11/10; B65H 2701/36

(57) ABSTRACT

The disclosure provides a hose manufacturing machine, which includes a spool and a pintle assembly. The spool rotates about a central axis. The pintle assembly includes a spindle and a brake arrangement. A first end of the spindle is attached to the spool along the central axis. The brake arrangement includes a brake disc and a force plate. The brake disc includes a brake surface and is attached to a second end of the spindle. The force plate includes a number of brake pads. The brake pads has a relatively higher wear coefficient than the brake disc. The brake pads of the force plate contact the brake surface of the brake disc to at least partially restrict the rotational motion of the spool.

### TECHNICAL FIELD

The present disclosure generally relates to a hose manufacturing machine. More particularly, the present disclosure relates to a pintle assembly of the hose manufacturing machine.

### BACKGROUND

Pressure hoses are commonly known to provide a fluid connection between two fluid components of a machine. A pressure hose typically includes a hollow elastomer core and a number of layers of spirally wound wires. A hose manufacturing machine is employed to manufacture such pressure hoses. Particularly, the hose manufacturing machine spirally winds the wires on the elastomer core, to manufacture the pressure hose.

The hose manufacturing machine includes a mandrel, a winding disc, a number of spools of the wires, and a number of pintle assemblies. The elastomer core is coaxially positioned on the mandrel. The wires are routed from the spool of wires, through the winding disc, to connect with the elastomer core. The winding disc is then rotated to spirally wind the wires on the elastomer core. Each pintle assembly is provided with each spool, to maintain tension in the wires being wound on the elastomer core. More specifically, each pintle assembly partially restricts a rotational motion of each spool, to maintain tension in the wires.

Conventionally, the pintle assembly employs a spindle and a brake arrangement. The spindle is connected to and rotates with the spool. The brake arrangement includes a brake disc and a force plate. The brake disc is connected to and rotates with the spool. The brake disc includes a rough brake surface. The force plate is stationary and supports a number of brake pads. The brake pads of the force plate contact the brake surface of the brake disc, to at least partially restrict the rotational motion of the spool. As the brake surface is machine rough, with continuous and prolonged operation, the brake surface of the brake disc is irregularly worn out. Such wearing of the brake surface of the brake disc causes uneven braking by the braking arrangement of conventional pintle assemblies. This results in uneven tension in the wires being wound on the elastomer core.

U.S. Pat. No. 4,444,707 describes an apparatus (hose manufacturing machine) to manufacture the pressure hose. The apparatus includes a supply reel (the spool) and a pair of brake shoes (the brake arrangement). The pair of brake shoes brakes the supply reel, to alter tension in the wires. Although, this reference discloses usage of the brake shoes to brake the supply reel, no reference provides the brake arrangement that maintains substantially continuous and even tension in the wires.

Hence, there is a need for an improved brake arrangement of a pintle assembly of the hose manufacturing machine, which maintains substantially continuous and even tension in the wires wound on the elastomer core.

### SUMMARY OF THE DISCLOSURE

Various aspects of the present disclosure provide a hose manufacturing machine. The hose manufacturing machine includes a spool and a pintle assembly. The spool is adapted to rotate about a central axis. The pintle assembly includes a spindle and a brake arrangement. The spindle includes a first end and a second end. The first end of the spindle is attached to the spool along the central axis. The brake arrangement includes a brake disc and a force plate. The brake disc is attached to the second end of the spindle. The brake disc includes a brake surface. The force plate includes a plurality of brake pads. The brake pads has a relatively higher wear coefficient than the brake disc. The brake pads of the force plate further contact the brake surface of the brake disc to at least partially restrict the rotational motion of the spool.

### BRIEF DESCRIPTION OF THE DRAWINGS

FIG. 1 is a schematic of a hose manufacturing machine, illustrating a number of spools and a number of pintle assemblies of the hose manufacturing machine;

FIG. 2 is an exploded view of one of the pintle assemblies of FIG. 1, illustrating various components of the pintle assembly; and

FIG. 3 is a sectional view of the pintle assembly of FIG. 2, illustrating various components of the pintle assembly.

### DETAILED DESCRIPTION

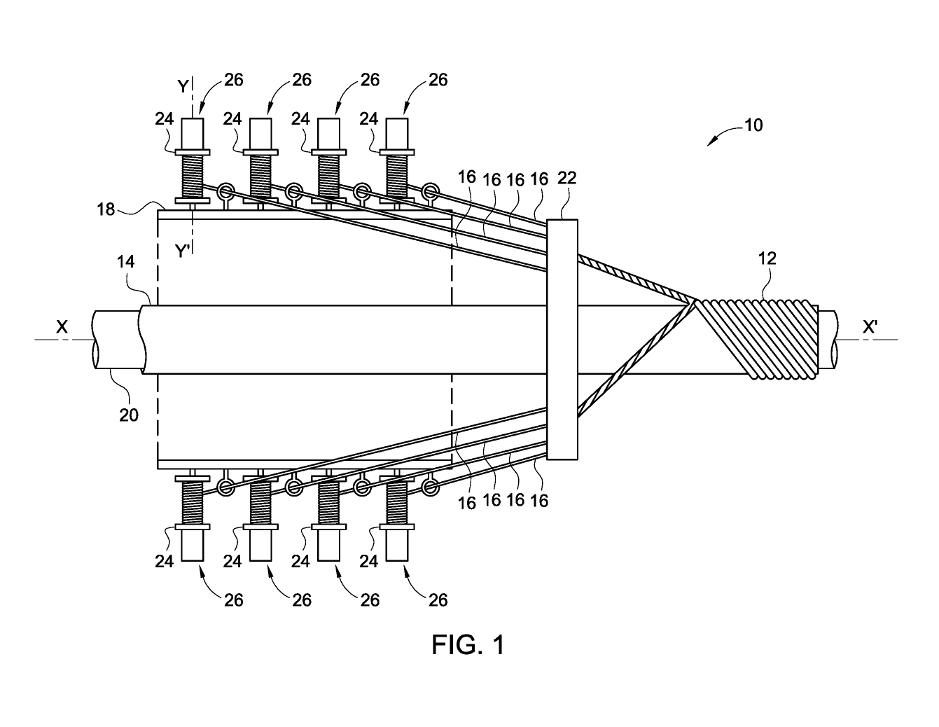

Referring to FIG. 1, there is shown a schematic of a hose manufacturing machine 10. The hose manufacturing machine 10 is employed to manufacture a pressure hose 12. The pressure hose 12 includes an elastomer core 14 and a number of layers of spirally wound wires 16. The hose manufacturing machine 10 spirally winds the layers of the wires 16 on the elastomer core 14, in order to manufacture the pressure hose 12. Although, the present disclosure describes a singular section of the hose manufacturing machine 10 for winding a singular layer of the wires 16 on the elastomer core 14, a number of similar sections of the hose manufacturing machine 10 for winding a number of layers of the wires 16 on the elastomer core 14 may be contemplated.

The hose manufacturing machine 10 includes a frame 18, a mandrel 20, a winding disc 22, a number of spools 24 of the wires 16, and a number of pintle assemblies 26. The frame 18 supports the mandrel 20, the winding disc 22, the spools 24, and the pintle assemblies 26. The mandrel 20 is installed on the frame 18 and is extended along a longitudinal axis X-X′. The winding disc 22 is rotatably installed on the frame 18. The winding disc 22 is coaxially aligned with the mandrel 20, such that the mandrel 20 extends through a mandrel opening (not shown) in the winding disc 22. The spools 24 are rotatably installed on the frame 18 and support the wires 16. More specifically, each spool 24 includes a central axis Y-Y′, about which the spool 24 performs a rotational motion.

In order to wind the wires 16 on the elastomer core 14, the elastomer core 14 is coaxially positioned on the mandrel 20. The elastomer core 14 linearly moves over the mandrel 20, along the longitudinal axis X-X′. The wires 16 are further routed from the spools 24, through a number of wire openings (not shown) in the winding disc 22, to connect with the elastomer core 14 on the mandrel 20. The winding disc 22 is rotated about the mandrel 20, to spirally wind the wires 16 on the elastomer core 14.

Furthermore, the pintle assemblies 26 impart tension in the wires 16, while the wires 16 are wound on the elastomer core 14. More specifically, each pintle assembly 26 restricts a rotational motion of each spool 24, to maintain tension in the wires 16 wound on the elastomer core 14. Structure and arrangement of a singular pintle assembly 26 to restrict a rotational motion of a singular spool 24 will be described in details hereinafter. Similar structure and arrangement of other pintle assemblies 26 to restrict a rotational motion of other spools 24 may also be contemplated.

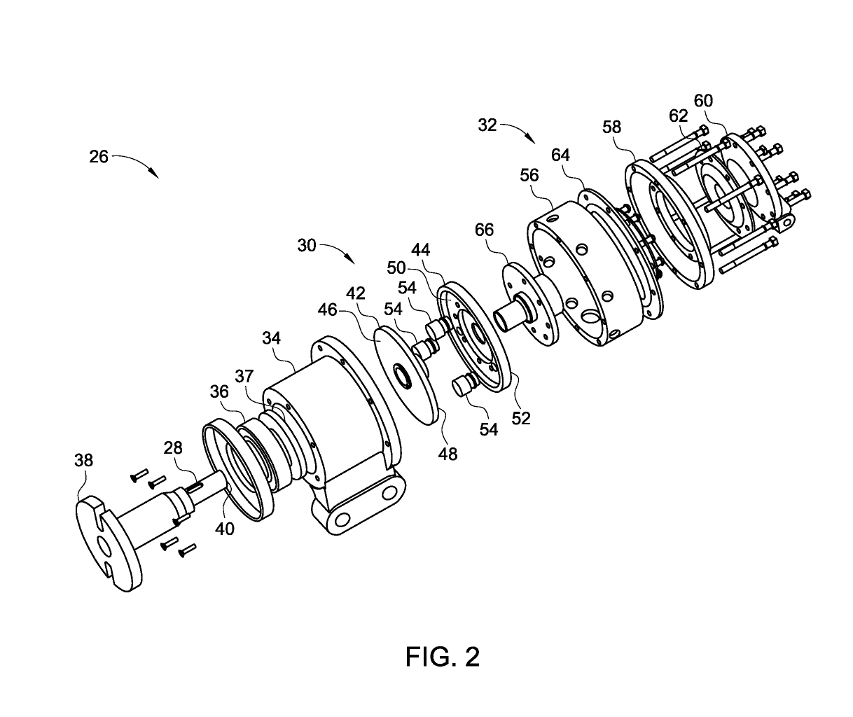

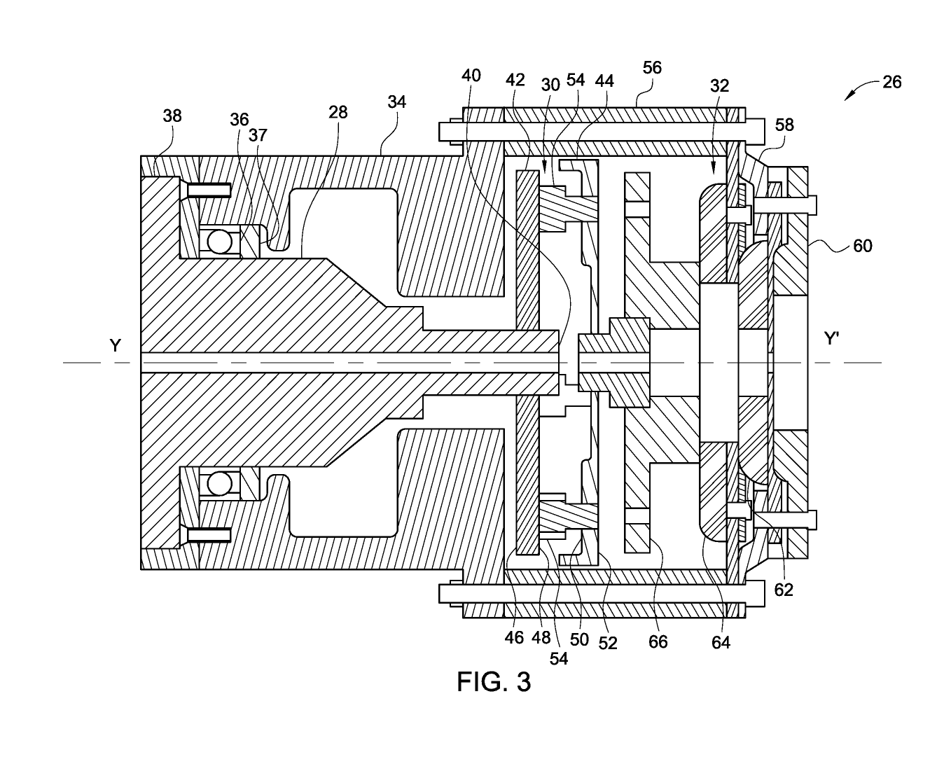

Referring to FIGS. 2 and 3, there is shown the pintle assembly 26 of the hose manufacturing machine 10. The pintle assembly 26 includes a spindle 28, a brake arrangement 30, and an actuation arrangement 32. For better understanding and clarity purposes, one or more components of the pintle assembly 26 are not shown in FIGS. 2 and 3.

The spindle 28 is rotatably supported within a spindle housing 34, via a bearing arrangement 36 and a spacer 37. More specifically, the bearing arrangement 36 is positioned within the spindle housing 34 and spaced apart from an inner portion of the spindle housing 34, along the central axis Y-Y′. The spacer 37 is positioned between the bearing arrangement 36 and the inner portion of the spindle housing 34, along the central axis Y-Y′. The spindle 28 further extends through the bearing arrangement 36 and the spacer 37, to be rotatably supported within the spindle housing 34. The spindle 28 includes a first end 38 and a second end 40. The first end 38 of the spindle 28 is attached to the spool 24. With such arrangement, the spindle 28 rotates with the spool 24 about the central axis Y-Y′. An attachment means between the first end 38 of the spindle 28 and the spool 24 includes, but is not limited to, a bolt attachment, a rivet attachment, an adhesive attachment, and a weld attachment.

The brake arrangement 30 partially brakes the spindle 28, to partially restrict a rotational motion of the spool 24. The brake arrangement 30 includes a brake disc 42 and a force plate 44.

The brake disc 42 is a steel disc fixedly attached to the second end 40 of the spindle 28. The brake disc 42 includes a connection surface 46 and a brake surface 48. The brake surface 48 is smooth surface with relatively lesser irregularities. With such arrangement, the brake disc 42 rotates along with the spindle 28. Although, the brake disc 42 is defined to be made of steel material, various other materials of the brake disc 42 may also be contemplated.

The force plate 44 is a steel disc supported within a component of the actuation arrangement 32. The force plate 44 includes a disc facing surface 50, an actuation surface 52, and a number of brake pads 54. The brake pads 54 are fixedly attached to the disc facing surface 50 of the force plate 44. The brake pads 54 are made of PAI (polyamide imide) plastic material, which has relatively higher wear coefficient than the brake disc 42. Although, the brake pads 54 are defined to be made of PAI (polyamide imide) plastic material, any other material for the brake pads 54 with relatively higher wear coefficient than the brake disc 42 may be contemplated.

The actuation arrangement 32 is an air-pressure actuated system that actuates the brake arrangement 30, to partially restrict the rotational motion of the spool 24. The actuation arrangement 32 includes an actuator housing 56, a spacer 58, an end cover 60, a first pressure bellow 62, a second pressure bellow 64, and a push component 66. Each of the actuator housing 56, the spacer 58, the end cover 60, the first pressure bellow 62, the second pressure bellow 64, and the push component 66 are arranged, such that an air pressure on the first pressure bellow 62 corresponds to a linear motion of the push component 66 along the central axis Y-Y′.

Furthermore, the brake disc 42 and the force plate 44 of the brake arrangement 30 are supported within the actuator housing 56 of the actuation arrangement 32, such that the linear motion of the push component 66 corresponds to the linear motion of the force plate 44. Correspondingly, such movement of the force plate 44 corresponds to a contact between the brake pads 54 and the brake surface 48 of the brake disc 42. Such contact between the brake pads 54 and the brake surface 48 partially restrict the rotational motion of the spindle 28.

### INDUSTRIAL APPLICABILITY

In operation, the hose manufacturing machine 10 is employed to manufacture the pressure hose 12. More specifically, the hose manufacturing machine 10 winds the layers of the wires 16 on the elastomer core 14, in order to manufacture the pressure hose 12. For such operation, the elastomer core 14 is initially positioned on the mandrel 20 of the hose manufacturing machine 10. The wires 16 are then routed from the spools 24, through a number of wire openings (not shown) in the winding disc 22, to connect with the elastomer core 14 on the mandrel 20. Thereafter, the winding disc 22 is rotated about the mandrel 20, to spirally wind the wires 16 on the elastomer core 14.

During such winding operation, the pintle assemblies 26 maintain tension in the wires 16. More specifically, the pintle assemblies 26 brake the corresponding spools 24, to maintain tension in the wires 16. For ease in reference and understanding, operation of a singular pintle assembly 26 for braking a singular spool 24 will be explained hereinafter, similar operation of other pintle assemblies 26 for braking other spools 24 may be contemplated.

In order to brake the spool 24, an air pressure is applied on the first pressure bellow 62 of the actuation arrangement 32. Application of the air pressure on the first pressure bellow 62 corresponds to a linear motion of the push component 66, which correspondingly actuates the brake arrangement 30. More specifically, a linear motion of the push component 66 corresponds to a linear motion of the force plate 44 of the brake arrangement 30. As the force plate 44 is linearly moved, the brake pads 54 of the force plate 44 partially contacts the brake surface 48 of the brake disc 42. This correspond to partial braking of the rotational motion of the spindle 28. Such braking of the spindle 28 corresponds to partial restriction of rotational motion of the spool 24.

During prolonged operations, one or more components of the pintle assembly 26 are worn out. As the replaceable brake pads 54 has a relatively higher wear coefficient than brake disc 42 and the brake surface 48 of the brake disc 42 has a smooth profile, the brake disc 42 is protected from wearing out. More specifically, a relatively higher wear coefficient of the brake pads 54 and the smooth profile of the brake surface 48 of the brake disc 42 avoids uneven wearing of one or more components of the pintle assembly 26. This corresponds to even and continuous braking of the spool 24 by the brake arrangement 30. Continuous and even braking of the spool 24 by such brake arrangement 30 of the pintle assembly 26 corresponds to even tension in the wire 16. This results in effective winding of the wire 16 on the elastomer core 14, during hose manufacturing.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claim(s) and any equivalents thereof

What is claimed is:

1. A hose manufacturing machine, comprising:
a spool adapted to rotate about a central axis; and
a pintle assembly, including:
a spindle including a first end and a second end, the first end of the spindle being attached to the spool along the central axis; and
a brake arrangement, including:
a brake disc attached to the second end of the spindle, the brake disc including a brake surface; and
a force plate including a plurality of brake pads, the plurality of brake pads including a relatively higher wear coefficient than the brake disc,
wherein the plurality of brake pads of the force plate contact the brake surface of the brake disc to at least partially restrict the rotational motion of the spool.
